(19) United States
(12) Patent Application Publication
(10) Pub. No.: US 2014/0021403 A1
(43) Pub. Date: Jan. 23, 2014

(54) CARBON NANOTUBE COMPOSITE AND METHOD OF MANUFACTURING THE SAME

(71) Applicant: Samsung Electronics Co., Ltd., Suwon-si (KR)

(72) Inventors: Ha-jin KIM, Hwaseong-si (KR); In-taek HAN, Seoul (KR); Shashikant PATOLE, Suwon-si (KR); Ji-beom YOO, Suwon-si (KR); Jae-hun JEONG, Suwon-si (KR)

(21) Appl. No.: 13/943,879

(22) Filed: Jul. 17, 2013

(30) Foreign Application Priority Data
Jul. 18, 2012 (KR) 10-2012-0078387

(51) Int. Cl. C01B 31/02

(52) U.S. Cl. CPC C01B 31/0273; C01B 31/022
USPC 252/182.32

(57) ABSTRACT

A carbon nanotube includes carbon nanotubes, and an entanglement member which is combined with the carbon nanotubes and has a three-dimensional shape.

### CROSS-REFERENCE TO RELATED APPLICATIONS

This application claims priority to Korean Patent Application No. 10-2012-0078387, filed on Jul. 18, 2012, and all the benefits accruing therefrom under 35 U.S.C. §119, the disclosure of which is incorporated herein in its entirety by reference.

### BACKGROUND

1. Field

Provided is a carbon nanotube (“CNT”) composite in which an entanglement member having a three-dimensional shape is disposed between CNTs so that a binding strength therebetween is enhanced, and a method of manufacturing the CNT composite.

2. Description of the Related Art

Research into the development of structural composites and electric and electronic components is being conducted. In particular, research into high-strength carbon materials has been undertaken. For carbon fibers used as a high-strength composite, the maximum strength thereof does not show any significant difference than previously achieved strengths. This means that there is limitation in improving the physical properties of carbon fibers. Therefore, research into the development of lightweight, strong materials is being conducted.

Carbon nanomaterials, particularly, carbon nanotubes (“CNT”s), have good mechanical, electrical and electronic characteristics. For effective use thereof, research into a method of preparing fibers using CNTs has been conducted. However, due to limitation in the growth length of CNTs, fiberization of the CNTs is difficult, and thus, various synthesis methods for fiberizing CNTs are being studied.

### SUMMARY

Provided is one or more carbon nanotube (“CNT”) composite including one or more entanglement member having a three-dimensional shape.

Provided is one or more method of manufacturing the CNT composite.

Additional aspects will be set forth in part in the description which follows and, in part, will be apparent from the description, or may be learned by practice of the presented embodiments.

According to an embodiment of the present invention, a carbon nanotube composite includes carbon nanotubes, and an entanglement member which is combined with the carbon nanotubes and has a three-dimensional shape.

The entanglement member may be a nano coil, nano tripod, or a nano wire having a curved portion.

An overall diameter of the entanglement member may be smaller than that of the carbon nanotube composite, and the entanglement member has an aspect ratio of 2 or more.

The carbon nanotube composite may be in the form of a fiber.

According to another embodiment of the present invention, a method of preparing a carbon nanotube composite includes providing carbon nanotubes; providing a solvent in which an entanglement member is dispersed; contacting the carbon nanotubes and a solvent in which the entanglement member is dispersed; and forming the carbon nanotube composite by combining the carbon nanotubes and the entanglement member, in the solvent.

The solvent may be an organic solvent, and the organic solvent may be an alcohol.

The method may further include, after contacting the carbon nanotubes and the solvent, stirring the solvent which is in contact with the carbon nanotubes.

The forming of the carbon nanotube composite may be performed in an ultrasonic bath.

The solvent may further include a dispersant which disperses the entanglement member in the solvent. The dispersant may be octylphenoxypolyethoxyethanol.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating a carbon nanotube (“CNT”) composite according to an embodiment;

FIG. 2 is a flowchart illustrating a method of manufacturing a CNT composite, according to an embodiment;

FIGS. 3A through 3C are perspective views illustrating a method of manufacturing a CNT composite, according to an embodiment;

FIG. 4A is a scanning electron microscopic (“SEM”) image of a CNT bundle, according to an embodiment;

FIG. 4B is a SEM image of a CNT composite in which CNTs and an entanglement member are combined together, according to an embodiment; and

FIG. 5 is a graph showing yield strengths of a CNT composite according to an embodiment and a general CNT fiber.

### DETAILED DESCRIPTION

Reference will now be made in detail to embodiments, examples of which are illustrated in the accompanying drawings, where like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

Carbon nanotubes (“CNT”s) themselves have excellent physical properties. For a CNT fiber formed of bundles of CNTs, however, overall mechanical strengths of the CNT fiber are determined by a binding strength between CNTs in the bundle. Since a general CNT fiber has a low binding strength between CNTs, slipping occurs between the CNTs, which may cause undesirable fractures of the CNT fibers. Therefore, there remains a need for an improved CNT fiber having an increased mechanical strength thereof, and an increased binding strength between CNTs.

Hereinafter, a CNT composite according to an embodiment of the present invention and a method of manufacturing the CNT composite will be described in detail with reference to the accompanying drawings. In the drawings, the thicknesses and widths of layers may be exaggerated for clarity.

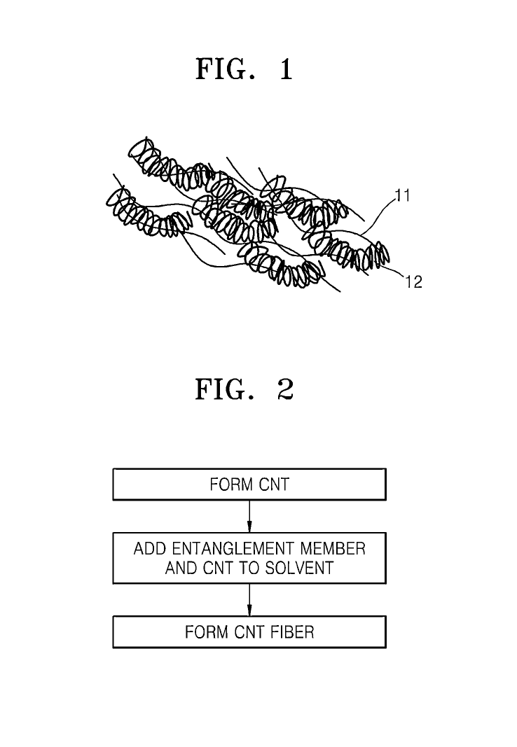

FIG. 1 is a perspective view illustrating a CNT composite according to an embodiment. Referring to FIG. 1, the CNT composite includes a plurality of CNTs 11 and an entanglement member 12 that binds the plurality of CNTs 11 together. While one CNT feature is specifically labeled 11 in FIG. 1, such reference number may also be used to refer to a collective group of CNTs in the present invention.

The CNTs 11 may be formed (e.g., provided) using various methods without particular limitation. In one embodiment, for example, the CNTs 11 may be single-walled or multi-walled CNTs. The CNTs 11 may be formed by laser deposition, thermal chemical vapor deposition, or the like. Each CNT 11 may have a length of at least 50 micrometers (pm) and a diameter of at least 1 nanometer (nm).

The entanglement member 12 improves a binding strength between the plurality of CNTs 11, and reduces or effectively prevents the occurrence of slipping between the CNTs 11. The entanglement member 12 may be a three-dimensional shaped nano filler, for example, a nano coil or a nano tripod, but not being limited thereto or thereby. The entanglement member 12 may be in a three-dimensional-shaped curved form, because, for a simple form extended in one direction such as nano wires, enhancing a binding strength between the CNTs 11 is difficult. For nanowires, however, a nano wire having a bent portion so as to form a three-dimensional shape and induce entanglement between the CNTs 11 may be used as the entanglement member 12. An overall diameter of an entanglement member 12 may be smaller than that of a CNT composite, for example, a CNT fiber bundle, and the entanglement member 12 may have an aspect (e.g., length to width) ratio of 2 or more.

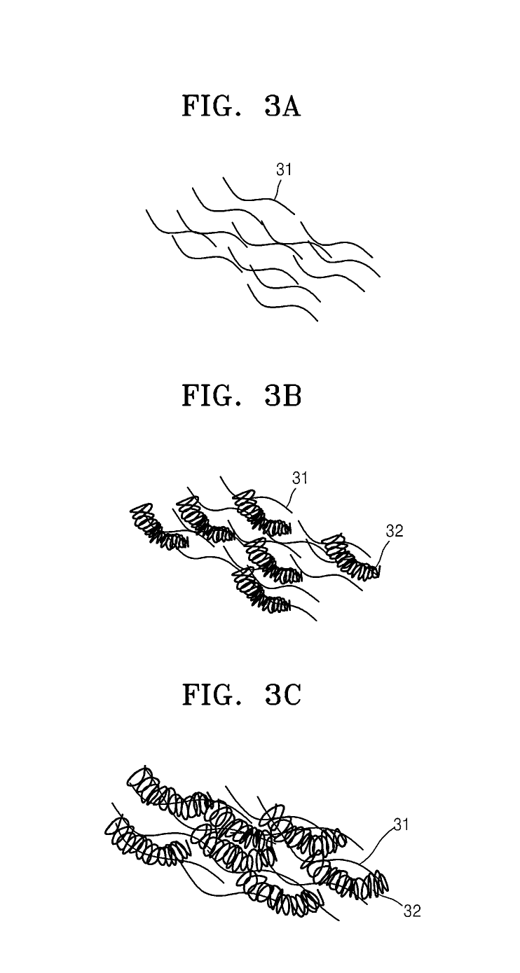

FIG. 2 is a flowchart illustrating a method of manufacturing a CNT composite, according to an embodiment. FIGS. 3A through 3C are perspective views illustrating a method of manufacturing a CNT, according to an embodiment.

Referring to FIG. 2, CNTs are formed (e.g., provided). The CNTs may be formed, as described above, using various methods, such as an arc-discharge method, laser deposition or thermal chemical vapor deposition, but not being limited thereto or thereby.

Hereinafter, an embodiment of a method of forming the CNTs will be described in detail.

First, a transition metal catalyst that is necessary for growing the CNTs is deposited on a silicon substrate. Methods of depositing the transition metal catalyst may vary and may include vapor deposition and liquid deposition. The transition metal catalyst may include at least one of Fe, Ni, Co, Pd, Pt, Ir, and Ru, and the scope of composition is without limitation. Methods of vapor deposition may include e-beam evaporation, sputtering, and chemical vapor deposition (“CVD”). Liquid deposition involves liquefying organic metal including a transition metal catalyst, and dip coating, spray coating, electro plating or electroless plating may be performed.

CNTs are grown by including a substrate on which the transition metal catalyst is deposited in a chemical vapor deposition chamber and injecting a carbon source gas and a carrier gas within a temperature degree of about 500 degrees Celsius (° C.) to about 1000° C. The carbon source gas may include at least one of C₂H₂, CH₄, C₂H₆ and CO, and may include a hydrocarbon, and may also include at least one of an alcohol, benzene and a xylene that are capable of supplying carbon by being dissolved by heat energy. The carrier gas may include at least one of Ar, H₂ and NH₃.

### Preparation Example

Al is deposited on a silicon substrate for the prevention of catalyst diffusion, and Fe is deposited above the Alt as a transition metal catalyst by using an electron beam (“E-beam”) evaporator. Al is deposited to a cross-sectional thickness of about 6 nm and at a deposition rate of about 0.2 angstrom per second (Å/sec). Fe is deposited to a thickness of about 2 nm and at a deposition rate of about 0.1 Å/sec.

The CNTs are synthesized using Fe as a catalyst by water-assisted CVD which can facilitate ‘super long’ growth. C₂H₂ is supplied to a chamber as a source gas at a flow rate of 200 standard cubic centimeters per minute (sccm). Ar is supplied to the chamber as a carrier gas at a flow rate of 480 sccm. Also, the flow rate of Ar is fixed to 170 sccm to facilitate an inflow of H₂O. These gases are supplied into the chamber, and the temperature of these gases is increased to 700° C. for 6 minutes. This temperature is maintained for about 10 minutes after the process of increasing the temperature. The flow rate of the supplying gases during the period in which the temperature is maintained is the same as the flow rate of the gasses that flow into the chamber during the process of increasing the temperature. After that, a natural cooling process is performed, during which only Ar is supplied into the chamber at a flow rate of 480 sccm. The length of the CNTs manufactured by this process is about 280 μm, and the density of the CNTs is 3969 CNTs per square micrometer (/μm²).

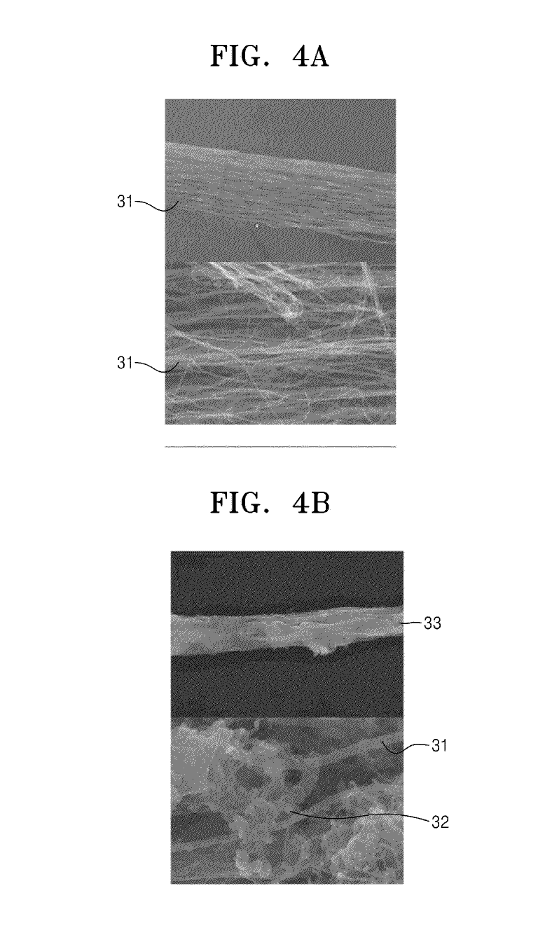

FIG. 3A shows an embodiment of a shape of initially-formed bundle of CNTs 31. A SEM image of the CNTs 31 formed as a bundle is illustrated in FIG. 4A. As shown in the top view of FIG. 4A, the plurality of initially-formed CNTs 31 forming a bundle themselves may be used as a CNT fiber. As shown in the bottom view of FIG. 4A, the plurality of initially-formed CNTs 31 may be included in a CNT composite including the CNTs 31 and a fiber-form entanglement member. Since a binding strength between the CNTs 31 is so weak that the CNTs 31 may be easily separated due to the occurrence of slipping therebetween, a fracture of the CNT composite may occur. Thus, to enhance the binding strength between the CNTs 31, a yarning process for binding the CNTs 31 together by using an entanglement member 32 is performed. The concentration of the entanglement member 32 may be between about 5 wt % to about 40 wt %, based on the total weight or concentration of the CNTs 31 and the entanglement member 32.

In one embodiment of binding the CNTs 31 together by using the entanglement member 32, the entanglement member 32 is dispersed in a solvent, and the CNTs 31 are added to a bath containing the resultant solvent. The solvent may be an organic solvent, such as acetone or an alcohol, e.g., ethanol, but not being limited thereto. In addition, a dispersant may be used to disperse the entanglement member 32 in the solvent. Various dispersants may be used according to the type of the solvent. In one embodiment, for example, when acetone is used as a solvent, a nonionic, octylphenol ethoxylate surfactant having excellent detergency and having a hydrophilic polyethylene oxide chain (e.g., on average having 9.5 ethylene oxide units) and an aromatic hydrocarbon lipophilic or hydrophobic group, such as t-octylphenoxypolyethoxyethanol, i.e., Triton™-X 100 (Dow Chemical Company), may be used as a dispersant.

As shown in FIG. 3B, when the CNTs 31 are added to the solvent including a dispersant, the CNTs 31 and the entanglement member 32 start to bind together to cause entanglement between the CNTs 31. In this regard, to induce the entanglement between the CNTs 31, a stirring process using a stirrer may be used or ultrasonic waves may be used. To use the ultrasonic waves in one embodiment, the manufacturing process may be performed in an ultrasonic bath with a solvent contained therein.

The binding process of the CNTs 31 and the entanglement member 32 in the solvent may be completed within several minutes to tens of minutes. As a result of the binding process, a CNT composite is formed. Afterwards, a drying process may be further performed.

FIG. 3C is a diagram illustrating a CNT composite formed using the method described above. The CNT composite includes the CNTs 31 and the entanglement member 32 which are bound together. The top view of FIG. 4B is a SEM image of the CNT composite 33 in which the CNTs 31 and the entanglement member 32 are bonded together. The bottom view of FIG. 4B is an enlarged view of the CNT composite 33, showing the CNTs 31 and the entanglement member 32 are bonded together.

Referring to FIGS. 3C and 4B, it is confirmed that the CNTs 31 are complicatedly entangled with the entanglement member 32. In the illustrated embodiment, a nano coil is used as the entanglement member 32, and it is confirmed that a plurality of nano coils are connected between the CNTs 31.

To evaluate mechanical characteristics of the CNT composite formed using the method of manufacturing the CNT composite, a yield strength of the CNT composite is measured. The measurement results are compared with that of a conventional CNT fiber including only CNTs (e.g., without an entanglement member).

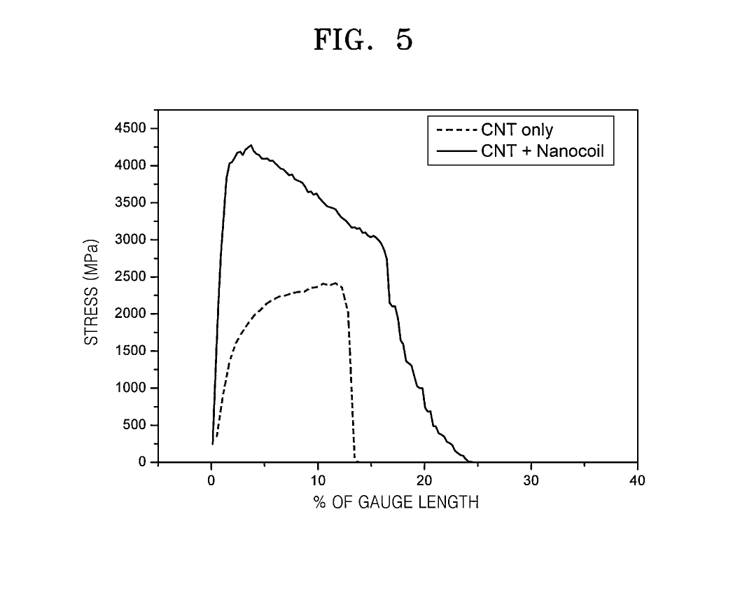

FIG. 5 is a graph showing yield strengths (Stress: megapascal (MPa)) of a CNT composite according to an embodiment and a general CNT fiber. The yield strengths of the graph of FIG. 5 are measured by a universal test machine under a measurement condition whereby a gauge length is about 1 centimeter (cm) at room temperature. The measurement test piece is a CNT composite (CNT+Nanocoil) of about 3 cm, in which CNTs manufactured according to an embodiment of the present invention and a nano coil of about 20 wt %, based on a total weight of the CNTs and the nano coil, are bonded together.

Referring to FIG. 5, the yield strength of the conventional CNT fiber (CNT only) including only CNTs is 2420 MPa, while the yield strength of the CNT composite (CNT+Nanocoil) is 4270 MPa. As a result of measurement, it is confirmed that the yield strength of the CNT composite is significantly improved. In addition, a tensile strength of the CNT fiber (CNT only) including only CNTs is measured to be about 2.5 GPa, and the yield strength of the CNT composite (CNT+Nanocoil) according to the present embodiment is measured to be 4.3 GPa, consequently confirming that the tensile strength is also significantly improved.

According to one or more embodiment of the present invention, the entanglement of the CNTs is induced using the entanglement member having a three-dimensional shape, such as a nano coil, thereby reducing or effectively preventing the occurrence of slipping between the CNTs and significantly improving mechanical properties such as a yield strength of the CNT composite.

In addition, in using one or more embodiment of a method of manufacturing the CNT composite of the present invention, the CNT composite may be produced at a large scale within a relatively short period of time, and thus, the method is highly efficient in terms of productivity.

As described above, according to one or more embodiment a CNT composite and a method of manufacturing the CNT composite of the present invention, CNTs are entangled with an entanglement member having a three-dimensional shape, whereby the occurrence of slipping between the CNTs may be reduced or effectively prevented. Therefore, mechanical properties such as a yield strength of the CNT composite may be improved.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A carbon nanotube composite comprising:
carbon nanotubes, and
an entanglement member which is combined with the carbon nanotubes and has a three-dimensional shape.

2. The carbon nanotube composite of claim 1, wherein the entanglement member comprises a nano coil, nano tripod or a nano wire, having a curved portion.

3. The carbon nanotube composite of claim 1, wherein
an overall diameter of the entanglement member is smaller than that of the carbon nanotube composite, and
the entanglement member has an aspect ratio of 2 or more.

4. The carbon nanotube composite of claim 1, wherein the carbon nanotube composite is in the form of a fiber.

5. A method of preparing a carbon nanotube composite, the method comprising:
providing carbon nanotubes;
providing a solvent in which an entanglement member is dispersed;
contacting the carbon nanotubes and the solvent in which the entanglement member is dispersed; and
forming the carbon nanotube composite by combining the carbon nanotubes and the entanglement member, in the solvent.

6. The method of claim 5, wherein the solvent comprises an organic solvent.

7. The method of claim 6, wherein the organic solvent comprises an alcohol.

8. The method of claim 5, further comprising, after contacting the carbon nanotubes and the solvent, stirring the solvent which is in contact with the carbon nanotubes.

9. The method of claim 5, wherein the forming the carbon nanotube composite is performed in an ultrasonic bath.

10. The method of claim 5, wherein the solvent further comprises a dispersant which disperses the entanglement member in the solvent.

11. The method of claim 10, wherein the dispersant comprises t-octylphenoxypolyethoxyethanol.

12. The method of claim 5, wherein the entanglement member comprises a nano coil, a nano tripod or a nano wire, having a curved portion.

13. The method of claim 5, wherein the carbon nanotube composite is in the form of a fiber.
